(19) United States
(12) Patent Application Publication
(10) Pub. No.: US 2005/0053766 A1
(43) Pub. Date: Mar. 10, 2005

(54) Primer to enhance adhesion to irregular surfaces

(76) Inventors: Adrian deKrom, Newbury, OH (US); Robert M. Shaw JR., Kirtland, OH (US)

Correspondence Address: ROBERT M. SHAW, ESQ;BIO-TECHNOLOGY GENERAL CORP., 1 TOWER CENTER, 14TH FLOOR, EAST BRUNSWICK, NJ, 08816, US

(21) Appl. No.: 10/656,959

(22) Filed: Sep. 8, 2003

(51) Int. Cl. B32B 1/00

(52) U.S. Cl. 428/141; 428/343

(57) ABSTRACT

A method, composition and article of manufacture are described to facilitate adhesion of one surface or substrate to a second irregular surface or substrate, such as a fibrous material, for example, paper or paper products. The composition of the invention is applied to the irregular surface where it fills in irregularities to present a smoother, more regular surface with enhanced adhesion properties.

### FIELD OF THE INVENTION

The present invention is directed to a method, composition, and article of manufacture for facilitating adhesion of otherwise irregular surfaces to one another. In particular, the invention is concerned with facilitating adhesive closure of parcels such as envelopes and packages where the irregular surfaces of paper, cardboard and other such materials may, to a degree, inhibit adhesion.

### BACKGROUND OF THE INVENTION

In recent years, there has been a steady increase in commerce by mail order and online auction sites. The products of this commerce are generally delivered by the U.S. Postal Service, United Parcel Service, and other delivery services. Such services require envelopes or packets appropriate to containing three dimensional objects. These envelopes are subject to greater stress than those intended for the flat, folded sheets of paper, which comprise traditional correspondence. Therefore, the adhesive used to seal such envelopes must form a stronger bond than those used with conventional envelopes and packets.

To meet this need, many very effective adhesives have been developed. These have progressed beyond the standard “lick and press”, to pressure adhesives that are covered with a liner tape. When the tape is removed, the adhesive is exposed and will adhere to the first surface against which it is pressed.

As good as all these adhesives may be, they all have one limitation. The surface against which they adhere is paper or paperboard. Paper may seem flat and smooth, but a microscopic view reveals that it is very textured, like a topography with peaks and valleys. So the adhesives pressed into contact with a receptive paper surface, can adhere only to the “peaks”, and not to the “valleys”. The adhesive may be contacting less than 25% of the receptive paper surface.

The present invention represents a whole new approach to increasing the effectiveness of adhesives. That new approach is directed to making the receptive paper surface less textured and more flat and even. This is accomplished by applying a primer which fills in the “valleys” and produces a greater receptive paper surface. With the adhesive contacting and adhering to nearly 100% of the receptive paper surface, a very strong bond results which will withstand all manner of stress and tendency to pull asunder.

### SUMMARY OF THE INVENTION

In accordance with the present invention, a method, composition and article of manufacture are provided for facilitating adhesion between two opposing surfaces, at least one which has surface irregularities owing, for example, to its texture or roughness.

According to the process of the invention, a fluid material is applied to the irregular surface to diminish the irregularities thereby providing a smoother, less irregular surface that presents a greater, more uniform contact surface for adhesive bonding to the other opposing surface. Typically, the irregular surface treated in accordance with the invention contains minuscule, often microscopic peaks and valleys found, for example, in fibrous materials such as paper or cardboard. By filling these valleys with the composition of the invention, followed by curing, a smoother, less irregular bonding surface is provided.

The fluid material applied to the irregular surface in accordance with the present invention is a composition comprising an aqueous mixture containing about 39-45 weight percent of an acrylic copolymer having carboxylic functionality, 2-4 weight percent ammonium hydroxide, 6-9 weight percent colloidal dispersion of fumed silica and 39-45 weight percent of a synthetic rubber dispersion, based on the total weight of the aqueous mixture. Typically, the amount of water will be 5-14 weight percent.

Preferably, the acrylic copolymer is a copolymer of ethylene acrylic acid and the rubber based adhesive is a resin modified water based dispersion of a styrene-isoprene-stryene unsaturated block copolymer.

The preferred composition for facilitating adhesive to an irregular surface in accordance with the invention is an aqueous mixture of about 39-43 weight percent of a dispersion of an ethylene acrylic acid copolymer, 5-14 weight percent water, 2-3 weight percent ammonium hydroxide, 39-43 weight percent of a resin modified, water based dispersion of a styrene-isoprene-stryene unsaturated block copolymer and 6-9 weight percent of a colloidal dispersion of fumed silica.

The present invention further includes an article of manufacture comprising a pair of opposing, sealable surfaces, such as the closure of an envelope or other parcel or package. Typically, one of the surfaces is provided with a pressure sensitive adhesive. The other opposing surface is intended to be adhesively bonded to the first surface and, usually, is made of the same fibrous material having a porous, irregular surface. In the article of manufacture according to the invention, the afore described composition is applied in a smooth, relatively thin and uniform layer to the opposing surface and allowed to cure, thereby presenting a smooth bonding surface, generally devoid of surface irregularities for receiving the surface provided with adhesive. Several techniques can be used to apply the composition to the surface. These include press applications such as gravure, lithography print and flexography.

The resulting adhesive bond between the two surfaces is thereby enhanced and strengthened over the bonding that results on untreated surfaces.

The invention will, however, be more fully appreciated by having reference to the following formulations, procedures and tests which are exemplary of preferred embodiments thereof.

Primer compositions of the invention were prepared having the following formulation:

| | | | | Weight | Weight |
|---|---|---|---|---|---|
| Commercial | | | | % | % |
| Name | Manufacturer | Type Component | Chemical Composition | A | B |
| Michemprime | Michelman, | Ethylene Acrylic | Polymer of Ethylene | 40.65 | 41.32 |
| 4990R | Inc. | Acid Dispersion | Acrylic Acid | | |
| Water | | | H₂O | 13.82 | 6.61 |
| Cab-O- | Cabot | Colloidal Fumed | SiO2 | 2.44 | 8.26 |
| Sperse | Corporation | Silica Aqueous | | | |
| PG001/Cab- | | Dispersion | | | |
| O-Sil | | | | | |
| Prinlin | Sovereign | Resin Modified | Styrene-Isoprene- | 40.65 | 41.32 |
| B7137A104 | Packaging | Water Based | Styrene Unsaturated | | |
| | Group, Inc. | Dispersion | Block Polymer | | |
| | | | Rubber | | |
| M-733 Hot | IFS | Modified Rubber | Styrene-Isoprene- | 0.0 | 0.0 |
| Melt | | Based Hot Melt | Styrene Copolymer | | |
| Adhesive | | PSA Adhesive | | | |
| #3 Zahn | | | | 30 sec. | 18 sec. |
| Viscosity | | | | | |
| pH | | | | 9.9 | 10 |

### EXAMPLE

Sample Preparation

Coating

USPS 13F Cascade board stock and USPS Cascade .012 CCNB Overnite Letter Envelope Stock were coated with the above primers using a ChemInstruments LC 100 laboratory coater and a #3 meyer rod.

The primer was pumped from the pail or drum unto an enclosed doctor blade system. At this point, the primer made contact with an analox roll. Testing, conducted on a series of primed board samples indicated that a 720 line screen analox roll gave the best performance at the most optimum coating level. The primer was taken up into the cell of the analox roll and metered by a stainless steel blade and transferred to the raised interior of the photopolymer printing plate. Following this, the primer was transferred to the substrate (board) according to the pattern on the printing plate.

Following this the coating was dried in a forced air oven using enough temperature to thoroughly dry the coating.

Sample Conditioning

All test samples were conditioned at 73±3° F. and 50±5% Relative Humidity for at least 24 hours prior to testing.

Testing

Loop Tack

Loop tack was tested according to the ASTM D 6195 (PSTC-16) modified test method on a ChemInstruments LT-1000 Loop Tack Tester. Chemsultants Looptack Tester is A2LA accredited for this method.

An 1″×5″ sample was prepared then formed into a loop with the adhesive exposed on the outside. A half-inch strip of masking tape was used to hold the loop together at the top. The loop was placed in the tester and lowered at a rate of 12 in./min. toward the substrate below. The adhesive made a square inch contact patch with the substrate. When the jaw was at the bottom of its travel, the direction of the jaw automatically reversed. As the adhesive was pulled from the substrate, the maximum force experienced during its removal was measured and recorded. Five replicates of each sample were tested.

The modification included the use of the clay coated side of the Cascade board with and without primer. The board was adhered to the stainless steel test panel using aggressive 2-sided tape and allowed to dry for 24 hours at 73° F., 50% RH prior to testing.

T-Peel

T-Peel was determined according to a modified ASTM D 1876 method on a ChemInstruments TT-1000 tensile tester. The modifications included the sample dimensions, conditioning period, and the test speed.

Laminated samples were allowed to dwell for 24 hours at 73° F./50% relative humidity environment, the constructions were pulled apart at a rate of 12.0 in/min. over a length of at least 5.0 inch. The force required to separate the bond was measured and averaged and the mode of failure was noted. Two replicates of each sample were tested.

TEST RESULTS

| | CONTROL | SAMPLE A | SAMPLE B |
|---|---|---|---|
| Loop Tack (mod.) | | | |
| (grams/in.²) | | | |
| Mode of Failure | 882 fiber tear | 922 fiber tear | 977 fiber tear |
| Probe Tack | 352 | 352 | 352 |
| (grams/cm.²) | | | |
| T-Peel (#/in.) | | | |
| Mode of failure | 1.33 fiber tear | 1.38 fiber tear | 1.57 fiber tear |

1. A process for facilitating adhesion to an irregular surface comprising applying a fluid material to said irregular surface to diminish irregularities in the surface thereby providing a smoother, less irregular surface presenting a greater, more uniform surface for adhesive bonding.

2. The process of claim 1, wherein said irregular surface contains minuscule peaks and valleys, said valleys being thereby filled with said fluid material to provide said smoother, less irregular surface.

3. The process of claim 1, wherein said fluid material is a composition comprising an aqueous mixture containing about 39-45 weight percent of an acrylic copolymer having carboxylic acid functionality, 2-4 weight percent ammonium hydroxide, 6-9 weight percent colloidal dispersion of fumed silica and 39-45 weight percent block copolymer styrene-isoprene-styrene emulsion, based on the total weight of the aqueous mixture.

4. The process of claim 3, wherein water is in the mixture in a weight percent of 5-14 percent.

5. The process of claim 1 wherein said irregular surface is the surface of a fibrous material.

6. The process of claim 5 wherein said fibrous material is paper.

7. The process of claim 5 wherein said fibrous material is cardboard.

8. The process of claim 3, wherein said acrylic copolymer is a copolymer of ethylene acrylic acid and said rubber based adhesive is a resin modified water based dispersion of a styrene-isoprene-styrene unsaturated block copolymer.

9. A composition for facilitating adhesion to an irregular surface comprising an aqueous mixture containing about 39-45 weight percent of an acrylic acid having carboxylic acid functionality, 2-4 weight percent ammonium hydroxide, 6-9 weight percent colloidal dispersion fumed silica and 39-45 weight percent block copolymer styrene-isoprene-styrene emulsion, based on the total weight of the aqueous mixture.

10. The composition of claim 9 wherein water is in the mixture in a weight percent of 5-14 percent.

11. A composition for facilitating adhesion to an irregular surface comprising an aqueous mixture of about 39-45 weight percent of a dispersion of an ethylene acrylic acid copolymer, 5-14 weight percent water, 2-3 weight percent ammonium hydroxide, 39-43 weight percent of a resin modified, water based dispersion of a styrene-isoprene-styrene unsaturated block copolymer and 6-9 weight percent of a colloidal dispersion of fumed silica.

12. The composition of claim 11 wherein said irregular surface contains miniscule peaks and valleys, said valleys being thereby filled with said fluid material to provide said smoother, less irregular surface.

13. The composition of claim 11 wherein said irregular surface is the surface of a fibrous material.

14. The composition of claim 11 wherein said fibrous material is paper.

15. The composition of claim 11 wherein said fibrous material is cardboard.

16. An article of manufacture comprising first and second opposing surfaces that are sealable to one another, said first surface having an adhesive material coated on at least a portion thereof, said second surface being an irregular surface having applied thereto a composition for facilitating adhesion of said first surface by diminishing irregularities therein, said composition comprising an aqueous mixture of about 39-45 weight percent of a dispersion of an ethylene acrylic acid copolymer, 5-14 weight percent water, 2-3 weight percent ammonium hydroxide, 39-43 weight percent of a resin modified, water based dispersion of a styrene-isoprene-styrene unsaturated block copolymer and 6-9 weight percent of a colloidal dispersion of fumed silica.

17. The article of manufacture of claim 16 wherein said irregular surface is the surface of a fibrous material.

18. The article of manufacture of claim 16 wherein said fibrous material is paper.

19. The article of manufacture of claim 16 wherein said fibrous material is cardboard.

20. The article of manufacture of claim 16 wherein said composition comprises an aqueous mixture of containing about 39-45 weight percent of an acrylic copolymer having carboxylic acid functionality, 2-4 weight percent ammonium hydroxide, 6-9 weight percent colloidal dispersion fumed silica and 39-45 weight percent block copolymer styrene-isoprene-styrene emulsion, based on the total weight of the aqueous mixture.

21. The article of manufacture of claim 16 wherein said composition comprises an aqueous mixture of about 39-45 weight percent of a dispersion of an ethylene acrylic acid copolymer, 5-14 weight percent water, 2-3 weight percent ammonium hydroxide, 39-43 weight percent of a resin modified, water based dispersion of a styrene-isoprene-styrene unsaturated block copolymer and 6-9 weight percent of a colloidal dispersion of fumed silica.

22. The article of manufacture of claim 16 wherein said irregular surface contains miniscule peaks and valleys, said valleys being thereby filled with said fluid material to provide said smoother, less irregular surface.

23. The process of claim 1 wherein said fluid material is applied to said irregular surface by a process selected from gravure, lithography print and flexography.
